(19) United States
(12) Patent Application Publication
(10) Pub. No.: US 2011/0117885 A1
(43) Pub. Date: May 19, 2011

(54) Methods of Connecting A User Telephonically To Prerecorded Information By Text Keyword And Keyword Database

(75) Inventor: Isaac H. Sutton, New York, NY (US)

(73) Assignee: Go800, LLC, New York, NY (US)

(21) Appl. No.: 12/945,518

(22) Filed: Nov. 12, 2010

Related U.S. Application Data
(60) Provisional application No. 61/355,764, filed on Jun. 17, 2010.
(60) Provisional application No. 61/260,941, filed on Nov. 13, 2009.

(51) Int. Cl. H04L 12/58; H04M 11/00; H04W 4/00

(52) U.S. Cl. 455/412.1; 379/93.01; 455/466

(57) ABSTRACT

A method of connecting phone users telephonically to prerecorded information using text keywords and a keyword database is disclosed. Preferred methods of purchasing text keywords and changing the corresponding number or other attributes by website are also disclosed.

### REFERENCE TO RELATED APPLICATIONS

This application the benefit under 35 USC §119(e) to Provisional Application No. 61/355,764, filed Jun. 17, 2010, entitled “Methods of Connecting A User Telephonically To Prerecorded Information By Text Keyword And Keyword Database” and to Provisional Application No. 61/260,941, filed Nov. 13, 2009, entitled “Methods of Connecting A Mobile Phone User Telephonically By Text Keyword Using A Keyword Database.” The aforementioned Provisional Patent Applications are hereby incorporated herein by reference. This application is related to Nonprovisional patent application Ser. No. 12/699,253, filed Feb. 3, 2010, entitled “Methods of Connecting A Phone User Telephonically By Text Keyword Using A Keyword Database,” currently pending, which also claims the benefit of Provisional Application No. 61/260,941.

### BACKGROUND OF THE INVENTION

Text messaging, or texting, allows the user of a phone to send brief written messages. While the term most often refers to messages sent using the Short Message Service (SMS), it has been extended to include messages containing image, video, and sound content, such as MMS messages. Individual messages are referred to as “text messages” or “texts.”

The most common application of texting is person-to-person messaging, although text messages are also used to interact with automated systems, such as ordering products and services, or participating in contests. Advertisers and service providers use texts to notify mobile phone users about promotions, payment due dates, and other notifications that were previously sent by post or left as voicemail.

Publicly traded companies (and other investment vehicles) often need to make disclosures to their shareholders. Many times, current or potential shareholders would like current information regarding various publicly traded companies in order to make informed decisions regarding investments. While publicly traded companies often disseminate information, there is often significant time lag. Also, shareholders who may be away from their home or office may not receive timely information.

While prerecorded information at a particular phone number is well known in the art, most investors and shareholders are not able to remember the multiple digits of a telephone number for every company or fund. Many times when an investor would like up to date information regarding breaking company news in order to make decisions, the time lag inherent in finding the information could cost the investor important opportunities. People tend to remember company names, brands and ticker symbols much better than numbers.

Therefore, the need exists for a fast, inexpensive, easy-to-use method to receive information about companies. Leveraging modern communications to allow consumers to remember words, such as company names, brands or ticker symbols, rather than numbers would be advantageous. The applicant has invented a method that, in the preferred embodiment, leverages the text messaging capabilities of phones combined with a keyword database to provide improved methods of receiving prerecorded information.

### FIELD OF THE INVENTION

The invention pertains to the field of communications. More particularly, the invention pertains to a method of forming a telephonic connection to prerecorded information by receiving text corresponding to a company name, brand or ticker symbol. A keyword database is used to determine the correct telephonic connection based on the text keyword.

### DESCRIPTION OF RELATED ART

U.S. Pat. No. 6,694,007, the disclosure of which is hereby incorporated by reference, describes parsing a text message to connect a toll call. However, there is no disclosure of a keyword database that relates particular text to one or more particular numbers, such that a user is connected to prerecorded company information by texting a company name, brand or ticker symbol.

U.S. Pat. No. 5,966,652, the disclosure of which is hereby incorporated by reference, also describes a method of using text messages to create a phone connection. However, there is no disclosure of a keyword database that relates particular keyword text to a one or more phone numbers to facilitate a telephonic connection to prerecorded company information.

### SUMMARY OF THE INVENTION

The invention utilizes a keyword database that correlates keyword text to one or more phone numbers. For example, the database might correlate a company name or ticker symbol with one or more phone numbers for forming a telephonic connection to a prerecorded message. Moreover, methods for text keyword purchase by website are described.

### BRIEF DESCRIPTION OF THE DRAWINGS

FIG. 1 shows a flow chart for the preferred embodiment of obtaining the phone user information and text keyword for use in the invention;

FIG. 2 shows a flow chart for the preferred method of using the phone user information, the text keyword and the keyword database to create a phone connection between a phone user and prerecorded information; and

FIG. 3 shows a flow chart for the preferred embodiment of allowing customers to purchase text keywords by website.

### DEFINITIONS

For purposes of this application, the following definitions apply to various terms:

“Text keyword” is a string of text used to correspond to one or more phone numbers in a keyboard database.

For example, the text keyword might be a company name, brand or ticker symbol which then is related to one or more phone numbers that connect to prerecorded information related in some manner to the name, brand or ticker symbol.

“Keyword database” means an electronic database in any format or structure that correlates the text keywords with one or more relevant phone numbers.

### DETAILED DESCRIPTION OF THE INVENTION

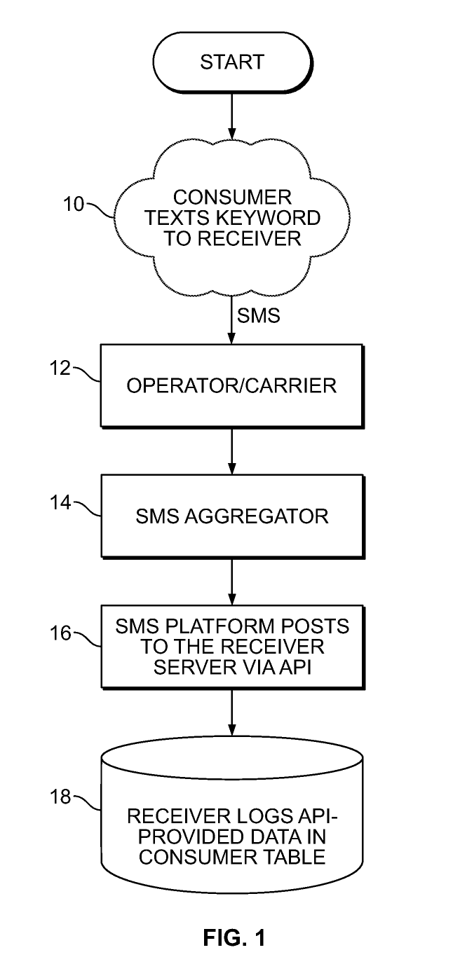

As shown in FIG. 1, the phone user (labeled “consumer”) sends a text keyword to a receiver (10). The user can be using any device capable of telephonic connection, including a cellular telephone or other device with telephone capabilities, such as various mobile devices. The receiver can be any electronic instrument capable of receiving a text keyword. In the preferred embodiment, the receiver is a typical five (5) digit commercial text message receiver. In the preferred embodiment, the text keyword is sent by Short Message Service (SMS), although the text could be sent by a variety of communication protocols, including MMS, email and any other data transmission protocol capable of sending a text string. In the preferred embodiment, the text keyword corresponds to a company name, brand or ticker symbol.

Thus, in the preferred embodiment, in order to reach prerecorded information about a desired company, the phone user does not need to remember a phone number. Instead, in the preferred embodiment, the phone user sends a keyword text message (the keyword being, for example, the company name, brand or ticker symbol) to the receiver. In the preferred embodiment, the phone user does not need know anything other than the company name, brand or ticker symbol in order to be connected telephonically. For the vast majority of phone users, this is far easier than trying to remember the minimum of seven digits that correspond to a particular phone number.

As shown in FIG. 1, in the preferred embodiment the operator/carrier (12) sends the text keyword by conventional SMS text transmission means to the SMS aggregator (14). In the preferred embodiment, SMS aggregator (14) then sends the SMS data to the SMS platform at the receiver using a known API (16). In the preferred embodiment, the receiver then logs the data provided by the API into a consumer table (18). While FIG. 1 shows the preferred embodiment, one of skill in the art would appreciate that there would be a variety of methods to implement the invention, and that the transmission, format and structure of the data may be implemented in a variety of ways. Different text protocols (such as email or other forms of data transmission) would use different steps, but would all result in a text keyword received from user.

As mentioned above, the structure and form of the data are not important, but must contain two critical pieces of information about the phone user—the user's phone number and the keyword text that corresponds to the company about which information is desired. SMS text messages contain the phone user's number and can easily transmit keyword text. In alternative embodiments that do not use SMS text, some data relating the text message to the user's phone number must be obtained, either by phone user registration or other alternatives known to those in the art.

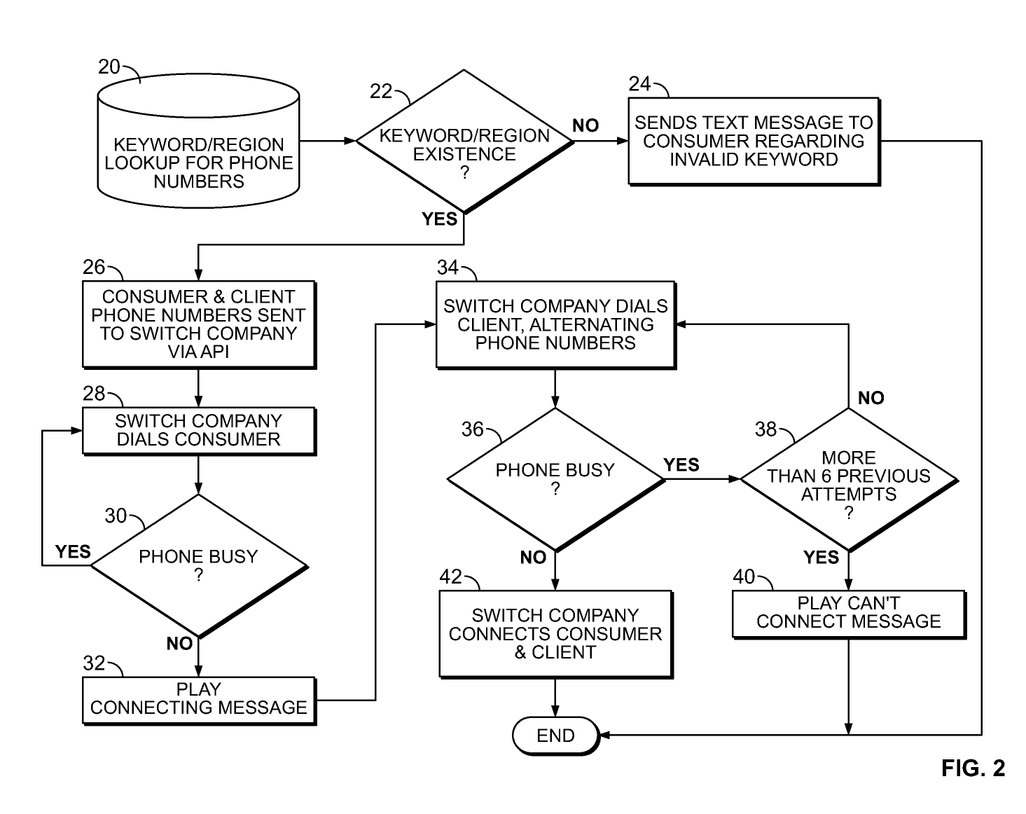

As shown in FIG. 2, the text keyword is applied to a keyword database which correlates keywords with phone numbers (20). The database may be regionally segregated by the area code of the phone user (or other information about the phone user which may be available, such as GPS data or through further communication with the phone user by text—such as requesting zip code or other information), although such geographic segregation is not required to practice the invention. One of skill in the art might have the system of the invention send a variety of messages to phone user. The text keyword may correspond to different numbers depending on the location of the location of the phone user or other data about the phone user, although such alternatives are not required to practice the invention.

As further shown in FIG. 2, in the preferred embodiment the text keyword is checked to make sure that a corresponding phone number exists for that text keyword (22). In the preferred embodiment, if no phone number exists that corresponds to the text sent by the phone user, a message conveying such is sent to the phone user (24).

As further shown in FIG. 2, assuming that a phone number corresponding to the text keyword exists, the phone number of the phone user sending the text keyword and the phone number that corresponds to the text keyword are sent to a phone switch (26). The phone switch may connect the two numbers—the user's mobile phone number sending the text keyword and the corresponding number from the keyword database—in any number of different methods known to those of skill in the art. The switch may be any component that allows for the connection between two phone numbers and may be a softswitch and/or utilize other components such as a feature server or media gateway controller.

In the preferred embodiment, the switch dials the mobile phone user first (28). In the preferred embodiment, if the phone user's line is busy, the switch company continues to try and contact the phone user until the phone user accepts the incoming call (30).

As shown in the preferred embodiment of FIG. 2, once the phone user that sent the keyword text accepts the incoming call, a message indicating that they are to be connected with the prerecorded information is sent from the switch company (32). This message may contain information about the connection services company providing the connection and/or indications that the consumer is going to be connected with one of the numbers associated with the text keyword in the keyword database, although such a message is not required to practice the invention.

As shown in the preferred embodiment of FIG. 2, the switch then attempts to connect the phone user to the phone number that corresponds to the text keyword in the keyword database (34). That connection will ultimately be to a device capable of playing a prerecorded message to the phone user. Thus, the phone user's text of, for example, the company name or ticker symbol results in a telephonic connection to prerecorded information about the company that corresponds to the company name, brand or ticker symbol. In the preferred embodiment, after numerous unsuccessful attempts (36), the switch carrier will abort the connection (38). In the preferred embodiment, under these circumstances, the switch carrier indicates to the phone user that the call cannot be completed (40).

As shown in the preferred embodiment of FIG. 2, the phone user and the phone number corresponding to the keyword are connected by the switch. In the preferred embodiment, the connection is at little to no expense to the phone user. Moreover, assuming the keyword database is accurately and expansively populated, a phone user need only remember the company name, brand or ticker symbol and the text receiver (which might be programmed automatically into the phone) in order to receive the prerecorded information about the company.

Other embodiments of the keyword database are also within the scope of the invention. The keyword database may be configured to connect different phone numbers in response to different input from the phone user, as described above. Another embodiment would allow manipulation of the connection numbers so that different numbers are used based on time of day, etc. Traditional phone number functions such as forwarding, call waiting, caller id, etc., while not necessary to practice the invention, are all possibilities.

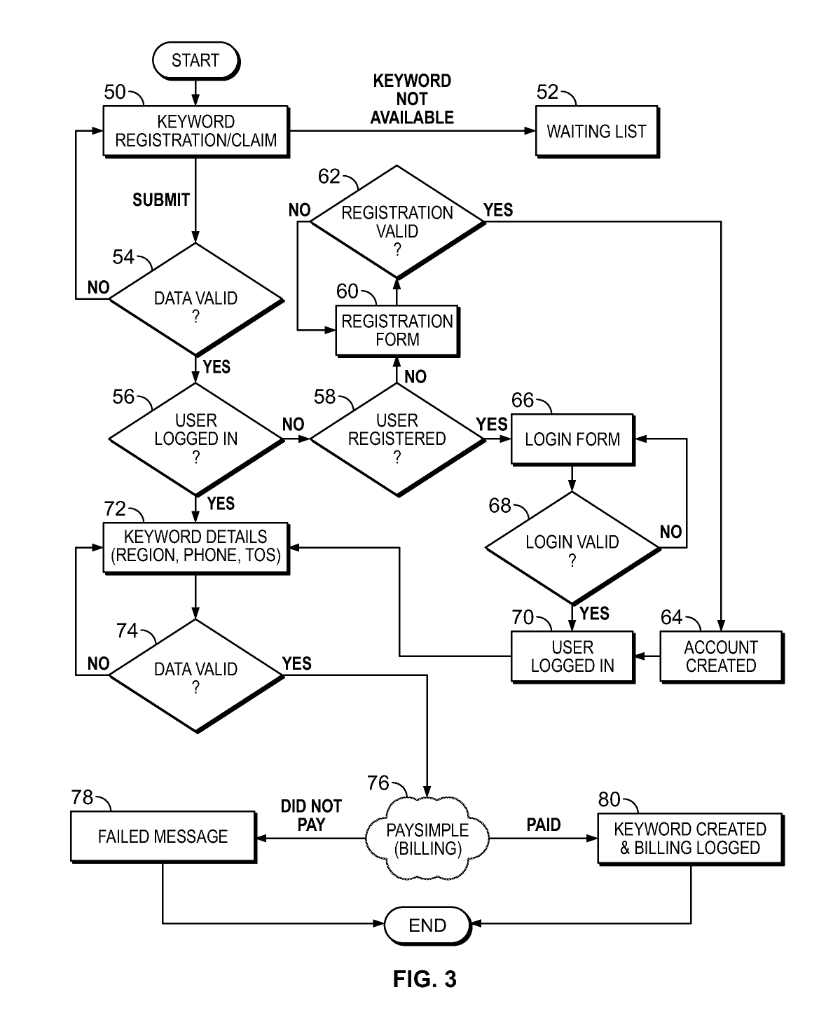

As shown in the preferred embodiment of FIG. 3, the invention also allows for a website-enabled registration process for text keywords, as well as entering corresponding numbers. In the preferred embodiment, the text keyword purchaser is first asked which text keyword is desired for purchase (50). In the preferred embodiment of FIG. 3, if the keyword has already been purchased, the purchaser is put on a waiting list in case the keyword becomes available (52). Another embodiment allows the website to generate automatic notices to companies when previously unavailable keywords become available for purchase.

In the preferred embodiment of FIG. 3, companies are only allowed to purchase text keywords that correspond to the company name or ticker symbol for the company. Various authentication and dispute resolution processes known in the art can be utilized for text keyword purchase. This is shown as the data validation step (54) in the preferred embodiment shown in FIG. 3. Moreover, the keyword is also checked to determine whether the form is permissible given the data structures and any other requirements of the text keyword receiver in the preferred embodiment.

As shown in the preferred embodiment of FIG. 3, the website uses a typical log in and registration process for those wishing to purchase keywords which are well known in the art. In the preferred embodiment, first the website determines if the user is logged in (56) using, for example, a username and password given as part of a typical registration process. If the purchaser has not logged in, the website determines if the purchaser is registered (58). If the purchaser is not registered, the website provides a typical registration form (60) and checks whether or not the registration form data is valid (62). Once valid data is entered into the registration form, then an account is created (64). Once the purchaser has a valid registration, the purchaser can log into the website (66) using typical means known in the art such as a username and password. Assuming the log in data is entered correctly (68) the purchaser is logged in (70). If the purchaser has previously registered, the purchaser can directly log into the website (56).

As shown in the preferred embodiment of FIG. 3, once the registered purchaser is logged in, various data related to the keyword purchase is acquired, including at least the phone number(s) that will correspond to the text keyword in the database (68). As previously described, a text keyword may correspond to different numbers, based on a variety of data, such as the geographic location of the mobile phone user, which may be determined by the area code of the mobile phone number, GPS or other electronic location data, or in response to text message inquiries. Other information, such as the terms of service, license, etc. may also be included in the preferred embodiment.

In the preferred embodiment of FIG. 3, the various data entered by the purchaser are checked for validity (74) and then billing for the text keyword is set up (76). Assuming no billing failure, which results in a message indicating such (78), then in the preferred embodiment the website creates the text keyword for use in the keyword database (80). In the preferred embodiment, billing for the keyword is also logged (80).

Although not shown, the phone numbers called in response to receipt of a text keyword could also be manipulated by website by the text keyword purchaser. Also not shown is the ability of the text keyword purchaser to enter different numbers in response to different data, such as location, time of day, etc., although such embodiments would be apparent to one of skill in the art.

Accordingly, it is to be understood that the embodiments of the invention herein described are merely illustrative of the application of the principles of the invention.

What is claimed is:

1. A method of connecting a user telephonically to prerecorded company information using a text keyword comprising:
a. receiving a text keyword from a user;
b. determining at least one phone number corresponding to the text keyword from a keyword database; and
c. connecting a user telephonically to prerecorded information using at least one phone number corresponding to the text keyword in the keyword database.

2. The method of claim 1, wherein the text keyword comprises a company name or brand.

3. The method of claim 1, wherein the text keyword comprises a ticker symbol.

4. The method of claim 1, wherein the text keyword is sent by SMS.

5. The method of claim 1, wherein a switch is used to connect the phone user with at least one telephone number corresponding to the text keyword in the keyword database.

6. The method of claim 5, wherein the switch includes one or more of the group consisting of a softswitch, feature server or media gateway controller.

7. The method of claim 1, wherein a website can be used to purchase the use of text keywords.

8. The method of claim 1, wherein a website can be used to change one or more phone numbers that correspond to a text keyword in a keyword database.

9. A method of connecting a user telephonically to prerecorded information using a text keyword comprising:
a. receiving a text keyword from a user of a cellular phone or mobile device;
b. determining at least one phone number corresponding to the text keyword from a keyword database;
c. connecting the user telephonically to at least one phone number corresponding to said text keyword, whereby the user receives prerecorded information over the connection.

10. The method of claim 9, wherein the text keyword comprises a company name, brand or a ticker symbol.

11. The method of claim 10, wherein the text keyword is sent by SMS.

12. The method of claim 11, wherein a switch is used to connect the user with at least one telephone number corresponding to the text keyword in the keyword database.

13. The method of claim 12, wherein a website can be used to purchase the use of text keywords.

14. The method of claim 13, wherein a website can be used to change one or more phone numbers that correspond to a text keyword in a keyword database.

15. A method of connecting a user telephonically to prerecorded information using a text keyword comprising:
a. receiving a text keyword via SMS from a user;
b. determining at least one phone number corresponding to the text keyword from a keyword database;
c. connecting the user telephonically to a phone number corresponding to said text keyword, whereby the user receives prerecorded information over the connection.

16. The method of claim 15, wherein the text keyword comprises a company name, brand, or a ticker symbol.

17. The method of claim 16, wherein the text keyword is received from a cellular phone or mobile device.

18. The method of claim 16, wherein a switch is used to connect a user with at least one telephone number corresponding to the text keyword in the keyword database.

19. The method of claim 18, wherein a website can be used to purchase the use of text keywords.

20. The method of claim 18, wherein a website can be used to change one or more phone numbers that correspond to a text keyword in a keyword database.
